(19) United States
(12) Patent Application Publication
(10) Pub. No.: US 2014/0314474 A1
(43) Pub. Date: Oct. 23, 2014

(54) FURNITURE UNIT

(71) Applicant: Juergen Fehre, Boebingen an der Rems (DE)

(72) Inventor: Juergen Fehre, Boebingen an der Rems (DE)

(73) Assignee: FEHRE DESIGN GMBH, Boebingen an der Rems (DE)

(21) Appl. No.: 14/241,836

(22) PCT Filed: Aug. 28, 2012
(86) PCT No.: PCT/EP2012/003609

§ 371 Date: Jul. 14, 2014

(30) Foreign Application Priority Data
Sep. 1, 2011 (DE) 10 2011 112 074.6

(51) Int. Cl. A47B 47/00; F16B 12/36; F16B 12/24

(52) U.S. Cl. CPC A47B 47/0091; F16B 12/24; F16B 12/36
USPC 403/292

(57) ABSTRACT

The invention relates to a furniture unit (1) having a box-shaped frame structure (2) delimited by two side panels (4), wherein one side panel (4) comprises at least two functional sections (5, 6), on which hardware sections (7) are arranged in order to mount furniture components (8) and in particular bottom parts thereon. One of the two functional sections (5, 6) serves as the front functional section and the other one as the rear functional section. The hardware section (7) extends between the front functional section (5) and the rear functional section (6) and is supported by both functional sections (5, 6). A first peg (9) extends from one of the two functional sections (5, 6) to a first slot (11) of the hardware section. A second peg (10) vertically offset thereto extends from one of the two functional sections (5, 6) to a second slot (12) of the hardware section (7) in order to support the hardware section (7).

The present invention relates to a furniture unit for a great variety of applications. The furniture unit is particularly preferably employed in kitchens. Use is also possible and preferred in rack and cabinet systems and in other modular furniture. A piece of furniture may consist of one single furniture unit or else of multiple, sectional furniture units which in turn form a larger furniture unit.

Various break-down furniture units have been disclosed in the prior art which are used for house and office furniture, for shelf systems in sales facilities and the like. These furniture units require little space for transport in their disassembled state. They can then be reassembled on site. A number of tools are required as a rule.

The time required and the complexity in assembling restrict the options for using these kinds of systems particularly in the case of furniture body elements complex in design.

DE 101 27 311 B4 discloses a furniture body configured to be disassembled and suitable for nearly no-tools assembly.

It is the object of the present invention to develop the known system further in an advantageous way so as to provide for easier assembly and/or improved functionality.

This object is solved by furniture units according to the invention having the features of the claims 1 and 13. Advantageous specific embodiments of the invention are the subjects of the subclaims. Further advantages and features of the invention can be taken from the general description and the description of the exemplary embodiments.

An inventive furniture unit according to claim 1 comprises at least one box-shaped frame body defined by a pair of side panels. At least one side panel comprises at least two functional sections with at least one fitting section disposed thereat for attaching at least one furniture element at the fitting section. At least one of the two functional sections serves as the front, and the other of the two functional sections, as the rear functional section. The fitting section extends between the front and rear functional sections and is supported on the two functional sections. At least one first peg extends from one of the two functional sections into a first groove of the fitting section. At least one second, vertically offset peg extends from one of the two functional sections into a second groove of the fitting section for supporting the fitting section.

The furniture unit according to the invention has many advantages. One considerable advantage of the furniture unit consists in the fact that mounting of the fitting section to the functional sections is easy and in particular requires no tools. The fact that first and second pegs vertically offset from one another are provided ensures reliable accommodation, which in particular results in firm accommodation of the fitting section and safety against overturning. This basically allows fastening any desired furniture attachment or furniture element to the fitting section.

It is particularly preferred to dispose at least one fitting section at each of the two side panels, i.e. at the functional sections on the right and the left of the frame body so as to support a furniture element on each side of the frame body. Symmetry of loads is thus achieved.

It is possible for the first peg to extend from the first functional section into one side or one end of the fitting section while the second peg extends from the other of the functional sections into the other of the sides or ends of the fitting section. It is also possible and preferred for the first and second pegs to extend from one of the two functional sections into the fitting section. The other of the fitting section ends may be supported in some other way or is supported on the functional section without any other hold.

The box-shaped frame body provides an accommodating space that may serve as a cabinet component or else for accommodating drawers or the like or other mechanical and/or electrical appliances.

The furniture unit may represent a separate piece of furniture or it may be part of a larger piece of furniture.

The fitting section is in particular provided for fastening shelves and/or fittings thereto. Drawers or other furniture units, trap doors for appliances and the like may likewise be attached thereto.

In a simple case the fitting section is pushed onto the first peg, i.e. hitched and then rotated until it latches onto the second peg. By way of the inserted furniture element the fitting section is thus received and/or locked secure against loss.

Preferably the fitting section is configured as a narrow, upright section. This means that in its installed state the height of the upright section is at least twice its width. The upright section may be rectangular in cross section and may in particular comprise at least one rounded corner.

Particularly preferably the first groove is disposed on an inner longitudinal face while the second groove is provided on the outer longitudinal face of the fitting section. The inner longitudinal face is disposed on the inner face of the frame body, facing the furniture element. The outer longitudinal face is that facing outwardly from the box-shaped accommodating space.

Preferably the fitting section is provided with at least one further groove preferably beneath the first and/or second groove and in particular on the outer longitudinal face.

The further groove is in particular suitable for no-tools accommodation and attachment of a furniture element in the shape of an add-on or built-in furniture element. It may for example accommodate shelves, drawers or the like in that a fitting or the like is inserted into the further groove and connected with the drawer.

In all the configurations it is possible for at least one groove to extend over the entire length of the fitting section. Both the first and the second and also the further groove may extend over only part or else over the entire length of the fitting section.

Basically it is conceivable for at least one peg to extend from the front functional section to the rear functional section. This is possible in particular in the case of a groove extending over the entire length of the fitting section. It is also possible and preferred for the pegs to extend into the functional section for a specific length only. A length between twice and twenty times the peg diameter is preferred.

It is particularly preferred for at least one of the fitting section ends to be provided with at least two pegs. It is a particularly advantageous configuration to provide one of the fitting section ends with at least two pegs and the other of the fitting section ends with at least one peg. A simple configuration comprises two pegs each at either end of the fitting section.

Particularly preferably the top outer edge of the fitting section is shaped rounded or is at least approximately rounded in cross-section. The outer cross section may for example be configured stepped.

With the first groove disposed on an inner longitudinal face and the second groove disposed on the outer longitudinal face the fitting section can be guided from beneath to the first peg which enters the first groove with such movement. During the movement the fitting section is held transverse to the intended installed position so that the first groove approaches the first peg from beneath. After the first peg has entered the first groove, the fitting section can rotate downwardly about the pivot axis formed by the first peg until the second groove rests against the second peg, which has now entered the second groove. In this way the fitting section is prohibited from rotating further and it is received in the functional sections laterally secured. Furthermore the fitting section is vertically securely supported on the first and second pegs. A furniture element received between a pair of fitting sections secures the fitting sections.

To ensure that after inserting the first pegs into the first groove the fitting section rotates even if the furniture units or frame bodies are closely adjacent to one another, the outer top edge of the fitting section is preferably designed rounded.

Preferably at least the inner longitudinal face of the fitting section is provided with multiple holes, which are disposed in particular equidistantly, and at least in part at the same height. This results in a row of holes in the fitting section.

Preferably at least one hole is provided in the functional section at the height of the holes of the fitting section. In particular at least one functional section comprises a row of holes having multiple holes equidistant from one another.

In all the configurations it is preferred for at least one side panel to comprise a partition frame formed by at least one front functional section, at least one rear functional section, at least one top beam and at least one bottom beam. The two functional sections and the two beams are in particular articulated to one another. This creates in particular a type of articulated quadrangle, which may form a parallelogram though not necessarily.

Particularly preferably, adjacent frame bodies are provided with an exchangeable partition panel therebetween, which is in particular received at the partition frame. The partition panel may serve and be provided as bracing for the partition frame. After inserting the partition panel into the partition frame the partition frame is braced such that the frame components articulated to one another consisting of functional sections and top and bottom beams form a stable partition frame.

Another inventive furniture unit according to claim 13 comprises at least two adjacent, box-shaped accommodating spaces which are separated from one another by a partition frame. The partition frame comprises two front functional sections and two rear functional sections and a top and a bottom beam. The partition frame is supported on a top and a bottom cross bar. The front functional sections and the rear functional sections and the top and bottom beams are articulated to one another.

The bottom beam comprises an engaging lug for the support frame with the engaging lug at the bottom beam to engage and be retained in a slot at the bottom cross bar. The top beam engages and is retained in a slot of the top cross bar by means of at least one engaging lug.

This furniture unit according to the invention again has many advantages since it allows a simple and in particular nearly no-tools assembly. This allows low transport costs and reduced assembling costs. Higher flexibility in using and rebuilding the furniture unit according to the invention are also enabled.

One advantage consists in that the partition frame is not only held at the top cross bar by means of the engaging lug but it is also held by means of the engaging lug at the bottom beam in the bottom cross bar. No separate attachment by screws or the like is required so as to ensure very easy assembling.

The partition frame with the top and bottom beams and the front and rear functional sections is articulated like a four-bar mechanism.

Particularly preferably the top beam consists of two beam parts disposed in parallel. One of the two beam parts has a supporting lug and the other of the two beam parts, an engaging lug so that the partition frame engages the top cross bar by means of the engaging lug of the top beam.

A difference between the supporting lug and the engaging lug is that the engaging lug is configured angular so that it does not only rest on the cross bar but it enters into and latches in a slot by means of the engaging lug.

Particularly preferably the bottom beam consists of two beam parts disposed in parallel. One of the two beam parts shows a supporting lug and the other, an engaging lug. This allows the support frame to engage the bottom cross bar by means of the engaging lug of the bottom beam.

This means that the beam part having the engaging lug provides a secure hold on the cross bar while the beam part having the supporting lug serves as a support.

Particularly preferably the engaging lugs of the top and bottom beams are angular and facing one another. This means that the angular part of the engaging lug is angled downwardly at the top beam while the angular part of the engaging lug at the bottom beam is angled upwardly so that the two engaging lugs engage the slots in the top and bottom cross bars tong-like. This does not only allow supporting in the vertical direction but also a firm seat in the horizontal direction since the engaging lugs reach behind the panel surrounding the slot.

In all of these configurations the partition frame on the whole virtually consists of two part frames with the left part frame being formed by the functional sections on the left and top and bottom beam parts, and the right-side part frame, by the functional sections on the right and top and bottom beam parts. Each of the part frames shows one engaging lug only and one supporting lug only.

In this way the front and rear functional sections and top and bottom beam parts articulated to one another like a four-bar mechanism can thus be inserted in the slot in the top or bottom cross bar by means of the engaging lug at the part frame. The other of the part frames is inserted into the other of the slots at the bottom or top cross bar. Joining the two part frames to one another thus ensures a firm seat of the entire partition frame at the top and bottom cross bars. Each of the part frames can be pulled out of the top or bottom cross bar due to the articulated connection. This results in a particularly easy and concurrently secure assembly of the furniture unit according to the invention.

The front and rear functional sections and the top and bottom beams or beam parts are preferably provided with holes into which joint members can be pushed to form the four-bar mechanism.

Preferably at least one partition panel is received at the partition frame.

Particularly preferably the width of the beam is not larger than half the width of the partition panel. In particular is the width of a beam part or a beam not larger than half the width of the partition panel. This allows a beam frame to receive a partition panel in its entirety.

Advantageously at least one adjusting unit is provided at the partition frame. The adjusting unit serves in particular as a locking element and/or closing part and particularly preferably serves for locking the partition panel at the partition frame.

In preferred configurations a stackable frame body whose sides are formed by the partition frames defines the box-shaped accommodating space. At least one functional section of the partition frame shows top and/or bottom guide holes for inserting retaining pins, thus joining two stacked frame bodies to one another by means of said retaining pins.

This results in a particularly simple system of joining two frame bodies to form a furniture unit. To this end the two frame bodies are stacked on top of, and connected with, one another. The box-shaped accommodating space of the furniture unit is thus enlarged. This allows particular flexibility in partitioning the interior of the furniture unit. For example while a base cabinet element with a drawer has first been assembled, another frame body can be placed onto this element as needed at a later time so that after removing the drawers, shelves or the like a cabinet element of double or triple height is provided.

At least one frame body is retained at least at one of the cross bars.

In all the configurations preferably at least one fitting, shelf, box, at least one drawer, at least one door, at least one trap door or at least one appliance or the like is attached to the fitting section.

In the inventive configuration of the furniture unit according to claim 24 the furniture unit comprises at least one frame body that is received at a top and a bottom cross bar. Between the top and bottom cross bars at least two supporting sections are provided accommodating a rear panel between them. The rear panel consists of multiple panel sections identical in shape, each provided with a lateral groove on one side face and a lateral tongue on the other side face. The tongue of a panel section engages in the groove of the adjacent panel section. A first panel section engages in a lateral groove of the first supporting section and a last panel section engages by a tongue in a lateral groove of the second supporting section.

This furniture unit according to the invention again offers many advantages since it allows a simple and nearly no-tools assembly. The rear panel that is composed of identical panel sections provides flexibility in modifying the width of the furniture unit. Any desired width can be provided within the modular dimensions of the panel sections. An optically appealing rear panel ensues which may adjoin a living space and thus turns into an optically appealing visible surface.

In all the configurations at least one supporting section may comprise a front rabbet for accommodating a partition panel. In particular is the rabbet of the supporting section closed by means of a closing section.

In all the configurations the elements used may consist of different materials. Preferably the supporting sections consist of a metal and in particular of a light metal and they may for example be manufactured as an extruded section. While the functional sections may likewise be of a metal they may also be manufactured of wood or plastic. The cross bars and the top and bottom beams or beam parts preferably consist of a hard material such as metal. The cross bar is in particular attached to a wall of a building.

Further advantages and features of the present invention can be taken from the description of the exemplary embodiments, which will be discussed with reference to the following figures.

The figures show in:

FIG. 1 a partial view of a furniture unit according to the invention;

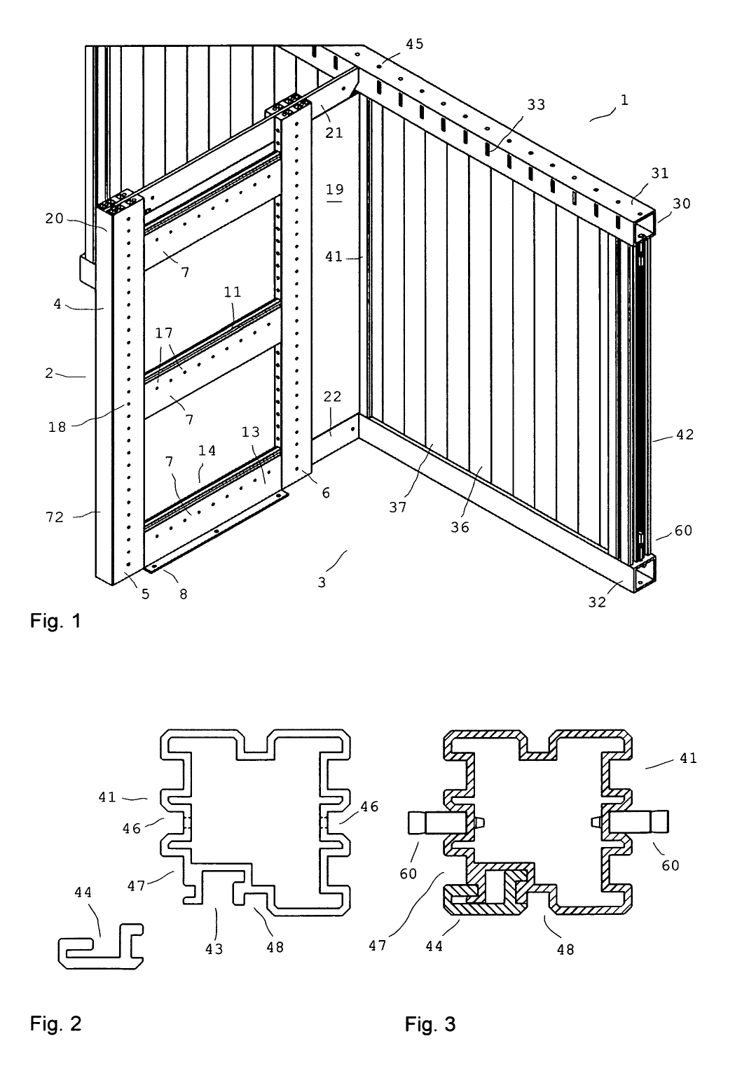

FIG. 2 a section of a supporting section with a separate closing section;

FIG. 3 a section of the functional section of FIG. 2 with the closing section mounted;

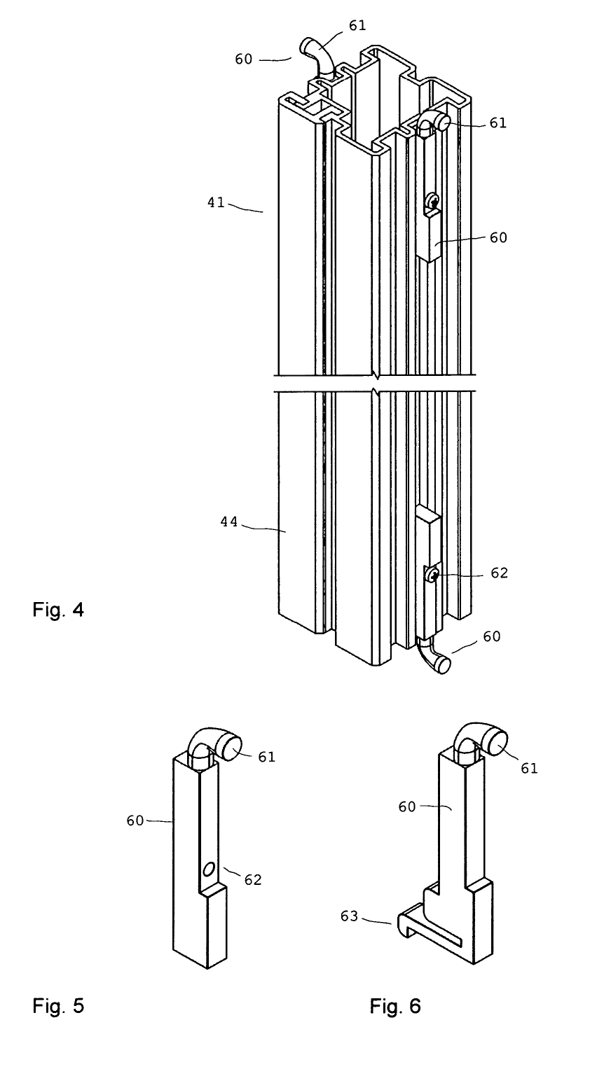

FIG. 4 a schematic, perspective view of a functional section with joint sections provided thereat;

FIG. 5 a joint section of FIG. 4;

FIG. 6 an alternative embodiment of the joint section of FIG. 5;

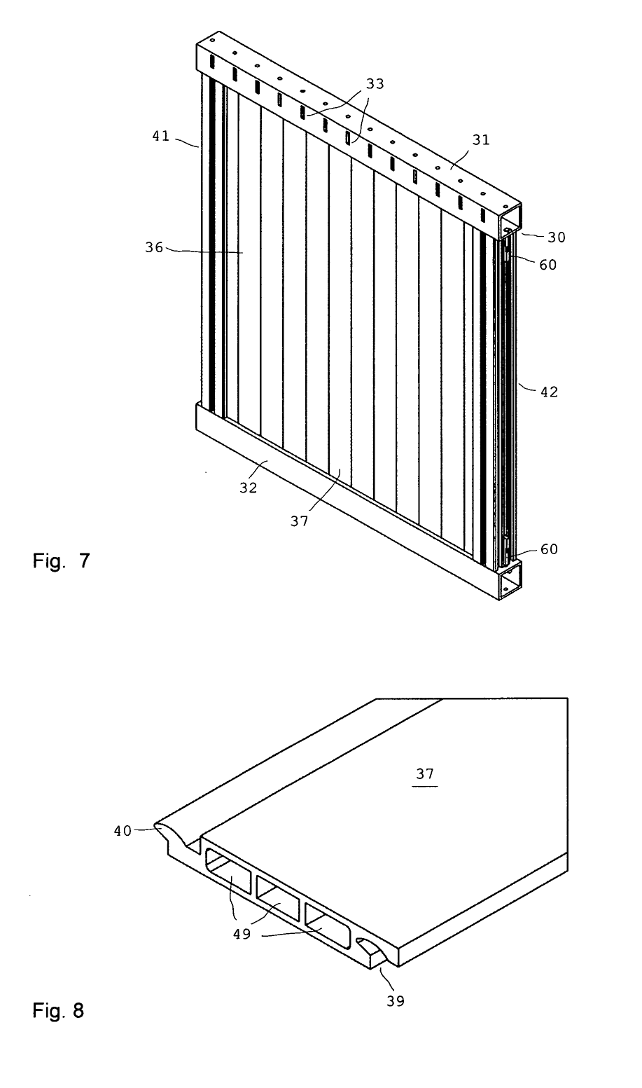

FIG. 7 a schematic, perspective view of a rear panel of the furniture unit of FIG. 1;

FIG. 8 a schematic, perspective view of a panel section of the rear panel of FIG. 7;

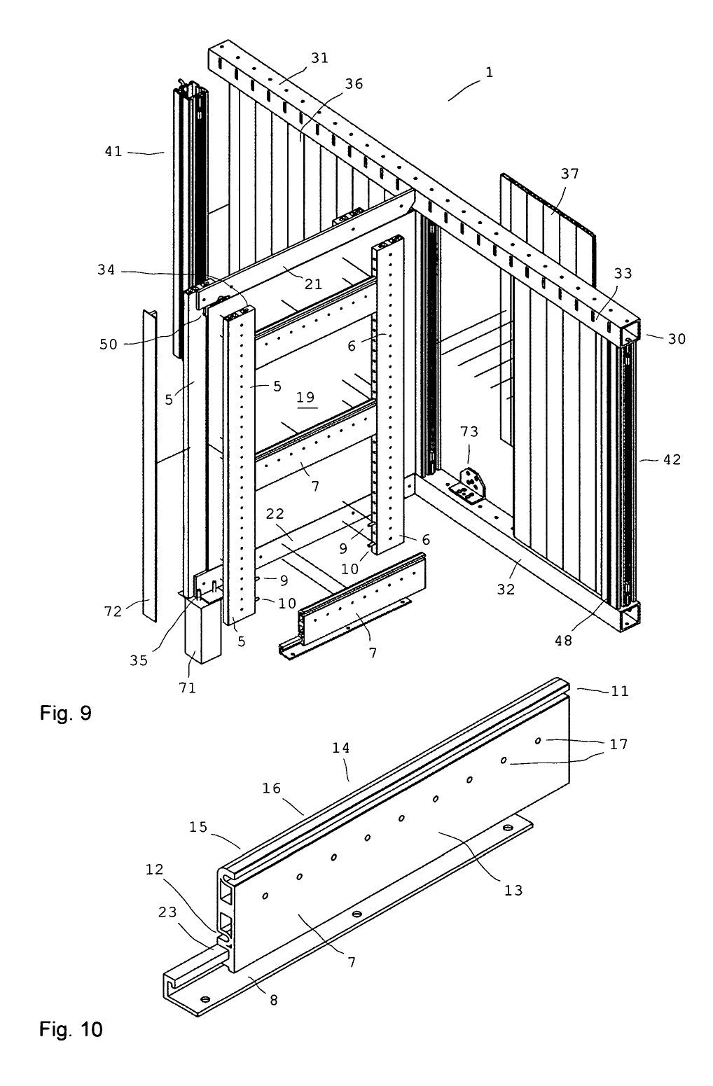

FIG. 9 a schematic, exploded view of part of a furniture unit according to the invention;

FIG. 10 an enlarged illustration of a fitting section;

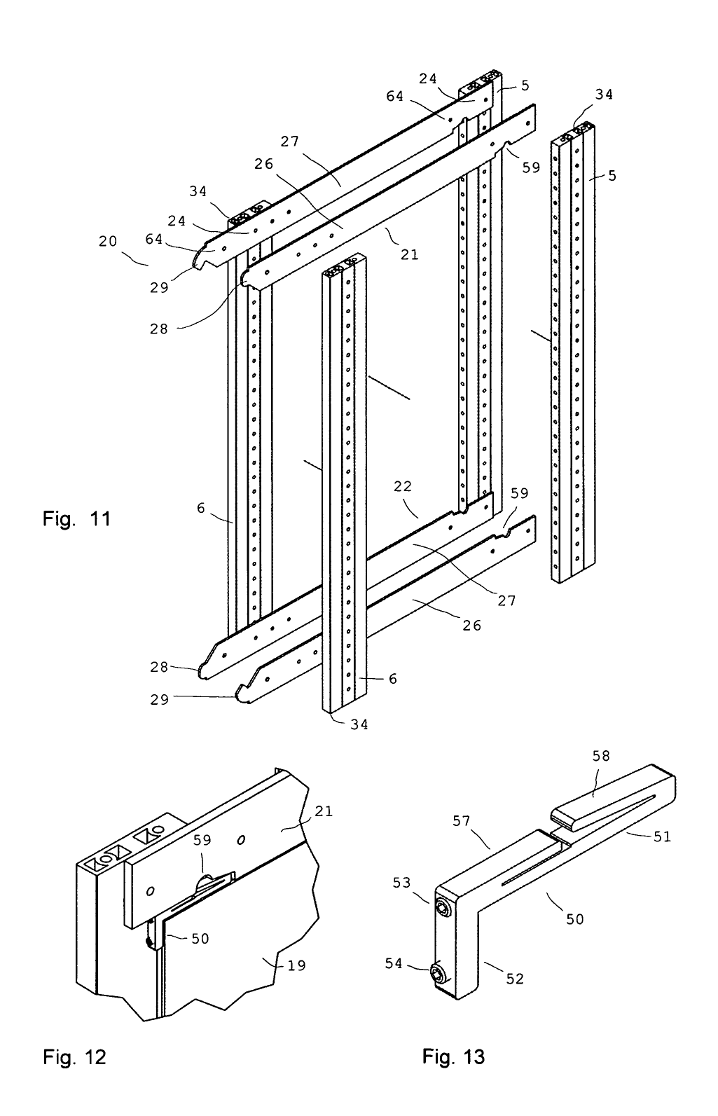

FIG. 11 another configuration of the partition frame of the furniture unit of FIG. 9;

FIG. 12 an enlarged illustration of a corner of the partition frame of FIG. 9;

FIG. 13 the adjusting unit for aligning the partition panel of FIG. 9;

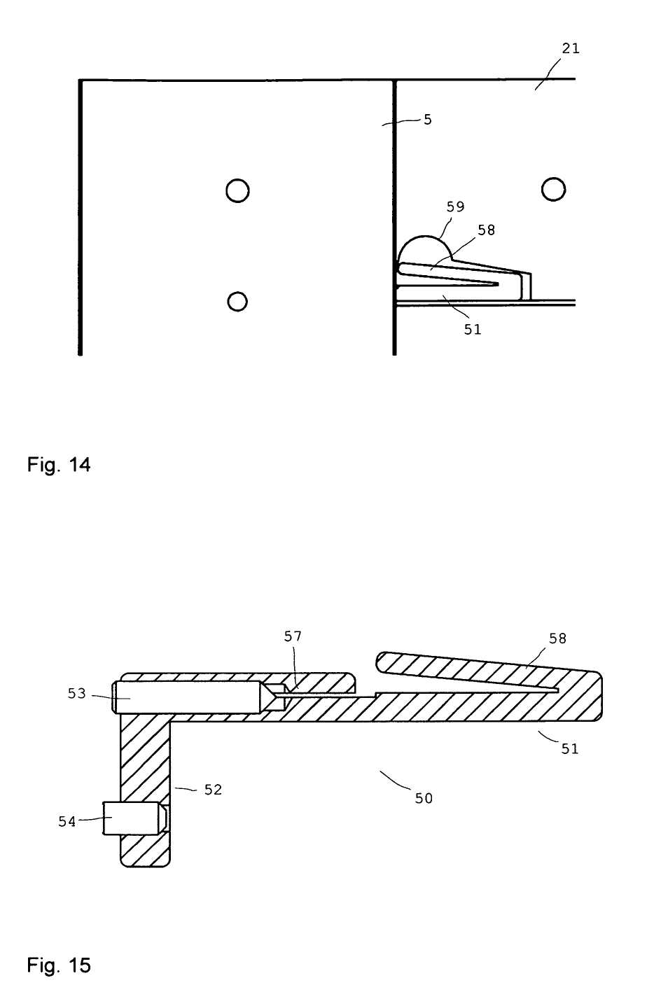

FIG. 14 the installing situation of the adjusting unit of FIG. 9;

FIG. 15 an enlarged cross section of the adjusting unit of FIG. 13;

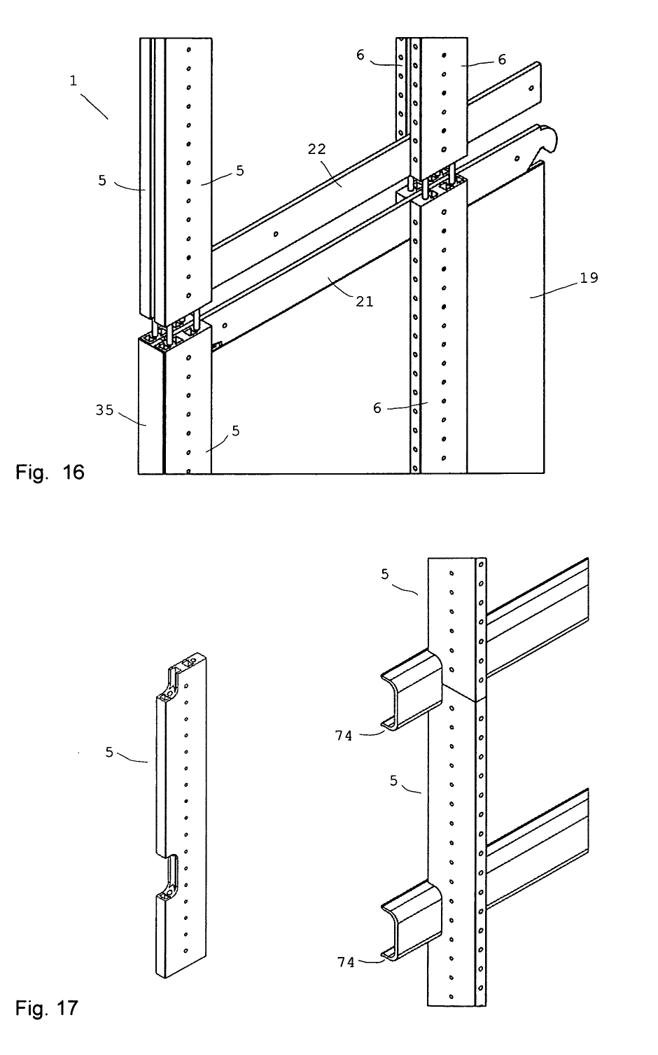

FIG. 16 two stacked frame bodies; and

FIG. 17 an alternative embodiment of a functional section and of two functional sections with a pulling device mounted.

With reference to the enclosed figures, exemplary embodiments of furniture units 1 according to the invention will be discussed below.

FIG. 1 shows a perspective representation of part of the furniture unit 1. The furniture unit shows a rear panel 36 that is modular in structure and includes single panel sections 37, which extend laterally between supporting sections 41 and 42 and in the height between a bottom cross bar 32 and a top cross bar 31. The panel sections 37 of the rear panel allow a modular structure and thus any desired width of the rear panel and thus of the furniture element, stepped in the widths of the panel sections 37.

The bottom cross bar 32 and the top cross bar 31 may for example be attached to a wall of a building, serving to support the entire furniture unit 1.

The top cross bar 31 comprises slots 33 for inserting a partition frame 20. To this end the partition frame 20 has an engaging lug 29, not shown in FIG. 1, at the top beam 21 the end of which is angular so that it latches into and is secured in the top cross bar 31.

The furniture unit 1 is provided with at least one frame body 2 that provides a box-shaped or square accommodating space 3 that is presently shown on the side in front of the partition frame 20. An accommodating space 3 is formed on the other side of the partition frame. The accommodating spaces 3 may serve to receive any desired furniture elements 8. The accommodating spaces 3 may for example be provided with drawers or electrical appliances or cabinet elements or the like.

The partition frame 20 comprises the top beam 21 and the bottom beam 22, and functional sections 5 and 6. Two functional sections 5 are provided as the front functional sections, receiving between them the top beam 21 in an upper region and the bottom beam 22 in a lower region. The two beams 21 and 22 and the functional sections are linked to one another in non-visible pivot points to form a four-bar mechanism.

The partition frame forms a side panel 4 of the frame body 2.

Three fitting sections 7 are disposed between the functional sections at different heights. Each of the fitting sections 7 comprises an inner longitudinal face 13 and an outer longitudinal face 14. The inner longitudinal face 13 is oriented toward the interior of the accommodating space 3, comprising a first groove 11 extending over the entire length of the fitting section 7.

Furthermore, holes 17 forming a row of holes are provided in the inner longitudinal face 13 of the fitting section 7. At the height of the holes 17 of the fitting section 7 there is also a hole 18 in the functional sections 5, 6. Preferably all the holes are spaced apart by specified and substantially equal distances.

The bottommost fitting section 7 shows a fitting as the furniture element 8 that is received in another groove 23 on the outer longitudinal face 14, not shown, of the fitting section 7. By means of the furniture element 8 that is presently formed as a bottom angle, further components such as shelves, drawer cabinets and the like can be attached to the furniture unit 1.

The partition panel frame 20 may comprise a partition panel 19 that may be made of standard materials. The partition panel 19 may for example be of glass and it may be transparent or opaque.

The top cross bar 31 and the bottom cross bar 32 are preferably identical in structure and may be positioned for example mirror-inverted. Both the cross bars may comprise top and bottom holes 45 disposed equidistantly in analogy to the slots 33. The holes 45 allow the mounting of different elements. For example joint sections 60 may be provided for joining the supporting sections 41, 42 to the cross bars 31, 32. The cross bars 31 and 32 and the supporting sections 41 and 42 form a base frame 30.

FIG. 2 shows a cross-section of a supporting section 41 with a closing section 44, not mounted. The supporting section 41 comprises various longitudinal grooves 46, 47, 43 and 48 etc. extending over the entire length of the supporting section 41 which is presently configured as an extruded hollow section.

The supporting section 41 preferably consists of a light metal such as aluminium or the like. Manufacturing from plastic or wood is likewise possible.

The side rabbet 47 may for example be provided for accommodating the rear panel 36 where a lateral end of a panel section 37 is pushed into the rabbet 47. Subsequently the rear panel is locked by attaching the closing section 44 so that the rear panel is securely received. This is the state shown in FIG. 3 where the closing section 44 has been attached to the supporting section 41.

FIG. 3 furthermore shows two joint sections 60 which are screwed to the supporting section 41 on both sides for joining the supporting section 41 to the top cross bar 31 or the bottom cross bar 32.

The front groove 48 may serve to receive the partition panel 19 which may furthermore be additionally fixed by way of the closing section 44.

Pushing the partition panel 19 into the partition frame 20 braces the partition frame 20 so that it retains the form shown in FIG. 1.

FIG. 4 shows a perspective view of a supporting section 41 with the closing section 44 mounted. One can clearly recognize the joint sections 60 with their angular heads 61. The joint sections 60 are retained in the top and bottom cross bars 31 and 32 by means of their angular heads 61. The joint sections 60 are screwed to the supporting section by screws 62 so that the joint sections 60 are fixedly connected with the supporting sections 41, 42 and with the top and bottom cross bars 31, 32. For securing the screws 62 a screw hole, which may be threaded, is provided at a specified distance from the ends of the supporting sections. It is also possible to use a thread-forming screw.

The joint section 60 of FIG. 4 is shown in FIG. 5 on an enlarged scale with the hole for the screw 62 recognizable.

Alternately a joint section 60 as it is illustrated in FIG. 6 may be used. This provides a no-screw attachment. The latch joint 63 allows pushing the joint section into a matched groove in the supporting sections 41, 42 in which it latches. This again allows a firm seat so as to provide a dependable joint between the cross bars and the supporting sections.

FIG. 7 is an enlarged, perspective illustration of the rear panel 36 of the furniture unit 1. The top cross bar 31 and the bottom cross bar 32 are joined together near or at their ends by way of supporting sections 41 and 42 to form a base frame 30. Between the supporting sections 41 and 42 the rear panel 36 with the panel sections 37 is provided.

Each single panel section 37 has a cross-section as it can be seen in FIG. 8. One of the panel section ends shows a continuous groove 39 while the other of the ends is provided with a continuous tongue 40. The groove 39 and the tongue 40 are dimensioned so that the tongue 40 of another panel section 37 precisely fits into the groove 39 of a first panel section. It can be inserted at an angle while subsequently the inserted section can be bent back to achieve straight alignment. This results in a firm seat of the rear panel 36.

Each of the panel sections 37 comprises a hollow space 49. The single panel sections may consist of a great variety of materials such as wood, plastic and metal, and in particular light metal. They may for example be of an aluminium material allowing an optically appealing design.

FIG. 9 illustrates a perspective, partially exploded, overview of a furniture unit 1. The illustration approximately corresponds to the FIG. 1. Some of the single panel sections 37 have been pulled off rearward from the rear panel 36. Behind the rear panel 36 an angle 73 is revealed that serves for example for securing the bottom cross bar 32 to a wall of a building.

The partition frame 20 consists of the front functional sections 5 and the rear functional sections 6, and of the top beam 21 and the bottom beam 22. The fitting sections 7 are retained at the partition frame 19 by means of pegs 9, 10.

The upper pegs 9 at the two functional sections 5 and 6 are inserted into the first groove 11. To this end the section is placed horizontal, the groove 11 facing upwardly, and placed on the pegs 9. Then the fitting section 7 is pivoted downwardly about the pivot point of the pegs 9 so that the second groove 12 bears against the second pegs 10. In this way the second pegs 10 are received in the second groove 12. The pegs 10 in the groove 12 prevent further outwardly movement while the first pegs 9 in the first groove 11 prevent inwardly movement of the fitting section 7. Furthermore the pegs 9, 10 reliably divert the forces acting from above.

Another groove 23 beneath the first and second grooves 11, 12 serves to receive a furniture element 8 configured in particular as a bottom angle or a shelf to allow attaching further components.

The partition frame 20 is supported downwardly by a base 71 on which retaining pins 35 are provided which are inserted into matching bottom apertures of the functional sections 5. A T-bar is pushed onto the partition frame 19 from the front, covering the gap between the two functional sections 5 in which the partition panel 19 has been inserted.

After inserting the partition panel 19, an adjusting unit 50 is pushed in between the partition panel 19 and the top beam 21 and latches into a recess or a notch 59 of the top beam 21.

FIG. 10 is an enlarged illustration of the fitting section 7 with the first groove 11, the second groove 12, and the further groove 23. The outer top edge 15 is rounded or stepped. The outer edge 15 shown has a radius 16 allowing free rotation of the fitting section 7 on the pegs 9 with the edge 15 of the fitting section 7 not protruding outwardly.

FIG. 11 shows the partition frame 20 comprising a top beam 21 and a bottom beam 22.

The beam 21 consists of the beam parts 26 and 27. The beam part 26 has a supporting lug 28 at its end while the beam part 27 has an engaging lug 29. At the other end of the beam parts 26 and 27 the notch 59 is provided for accommodating the adjusting unit 50.

Two functional sections 5 and two functional sections 6 and the top beam 21 and the bottom beam 22 together form the partition frame 20.

It is possible for a front functional section 5 and a rear functional section 6 and a beam part 26 and a beam part 27 to form a part frame where the single components are linked to one another in pivot points to form a four-bar mechanism. A second part frame is correspondingly formed of the same parts.

Now the part frames can be assembled to form the partition frame 20 according to FIG. 11 wherein two beam parts 26 and 27 are assembled such that one of the beam parts has the supporting lug at its front end and the other of the beam parts, the engaging lug at its front end, while the notches 59 at the other end lie parallel to one another and form in particular one shared notch 59.

This configuration allows to insert the part frame shown on the left in FIG. 11 with the engaging lug 29 from above into a slot 33 of the top cross bar. The supporting lug, which is then provided on the bottom, is supported in the slot 33 on the bottom cross bar 32. The other of the part frames presently shown on the right is preassembled identically and then rotated 180° so that the engaging lug 29 engages the slot 33 at the bottom cross bar 32 while the supporting lug 28 of the beam part 26 is supported in the slot 33 of the top cross bar 31. Such joining the two part frames in the pivot points 24 or the holes 64 allows a firm hold of the partition frame 20 at the cross bars 31 and 32. The angular shape of the engaging lugs 29 firmly retains the partition frame both in the vertical and the horizontal directions at the cross bars 31 and 32.

FIG. 12 is an enlarged illustration of the region of the adjusting unit 50 in the mounted state with the notch 59 at the top beam 21 visible.

FIG. 13 is an enlarged illustration of the adjusting unit 50, which has a long contacting leg 51 and a short contacting leg 52. The short contacting leg 52 is provided with adjusting screws 53 and 54. The adjusting screw 53 serves to adjust the height while the adjusting screw 54, being a continuous screw, relates to length adjustment.

The long contacting leg 51 is provided with a spring arm 58, which in the normal state protrudes upwardly.

When the adjusting unit 50 is pushed into the space between the partition panel 19 and the top beam 21 the spring arm 58 is first pressed downwardly until the spring arm resiliently rises in the offset 59 and is firmly wedged in the notch 59. This readily prevents the adjusting unit 50 from being pulled out.

FIG. 14 shows a much-enlarged detail of a lateral view with the region of the adjusting unit 50 in the installed state. The spring arm 58 is upwardly resiliently mounted in the notch 59 where it rests against the panel. In the case that dismantling is intended, the spring arm 58 must be pressed downwardly from the side with a tool or optionally with a finger of a hand so as to allow removal of the adjusting unit 50.

The distance of the notch 59 from the end of the beam is dimensioned such that the notch 59 is not covered by the functional section 5.

FIG. 15 shows a cross-section of the adjusting unit 50. The long contacting leg 51 of the adjusting unit 50 is provided with a slotted region 57 on which the adjusting screw 53 acts. With increasing depth of the screwed-in adjusting screw 53 the slotted region 57 expands so as to allow an adjustment of the height by means of the adjusting screw 53.

FIG. 16 shows two partition frames 20 stacked upon one another. The ends of the functional sections 5 and 6 are provided with guide holes 34 for inserting retaining pins 35 to retain a pair of functional sections 5 and a pair of functional sections 6 precisely vertically aligned.

This allows particular flexibility in the structure of the furniture units according to the invention since the height of various elements may be modified even at a later time. For example if a cabinet element is first used with a specific quantity of shelves or drawers and the height of this cabinet element is later intended to be expanded, then at least one matching part can be placed on top. Reversely it is also possible to remove various installations from one or more frame bodies and for example to use it as a higher cabinet or the like.

FIG. 17 shows a variant of a functional section 5 that is suitable for use with pulling devices 74. To this end, the functional sections may be provided with full recesses and half recesses in regular intervals serving to receive pulling devices 74 which extend across the front of the furniture unit. Half recesses at one of the ends allow particular flexibility of the structure.

The invention allows a basically unlimited expandability in height by the stacking capability. There is an increase in the functionality of the partition frame that comprises a simple, detachable bracing as a partition panel. The frame construction with detachable joint sections allows easy assembly. The slots disposed at defined lateral distances, and also the modular structure of the rear panel, allow the realization of flexible widths.

Fixed, non-detachable connections can be dispensed with which reduces transport costs and damage in transit. Moreover, re-use and re-construction in dependence on the currently prevailing requirements is possible.

List of reference numerals:

| | |
|---|---|
| 1 | furniture unit |
| 2 | frame body |
| 3 | accommodating space |
| 4 | side panel |
| 5 | functional section |
| 6 | functional section |
| 7 | fitting section |
| 8 | furniture element |
| 9 | first peg |
| 10 | second peg |
| 11 | first groove |
| 12 | second groove |
| 13 | inner longitudinal face |
| 14 | outer longitudinal face |
| 15 | outer edge |
| 16 | radius |
| 17 | hole |
| 18 | hole |
| 19 | partition panel |
| 20 | partition frame |
| 21 | top beam |
| 22 | bottom beam |
| 23 | further groove |
| 24 | pivot point |
| 25 | four-bar mechanism |
| 26 | beam part |
| 27 | beam part |
| 28 | supporting lug |
| 29 | engaging lug |
| 30 | base frame |
| 31 | top cross bar |
| 32 | bottom cross bar |
| 33 | slot |
| 34 | guide hole |
| 35 | retaining pin |
| 36 | rear panel |
| 37 | panel section |
| 38 | panel section |
| 39 | panel section groove |
| 40 | panel section tongue |
| 41 | supporting section |
| 42 | supporting section |
| 43 | rabbet |
| 44 | closing section |
| 45 | hole |
| 46 | groove (for 60) |
| 47 | rabbet |
| 48 | groove |
| 49 | space |
| 50 | adjusting unit |
| 51 | contacting leg |
| 52 | contacting leg |
| 53 | adjusting screw |
| 54 | adjusting screw |
| 55 | height |
| 56 | depth |
| 57 | slotted region |
| 58 | spring arm |
| 59 | notch |
| 60 | joint section |
| 61 | angular head |
| 62 | screw |
| 63 | latch joint |
| 64 | hole |
| 71 | base |
| 72 | T-bar |
| 73 | angle |
| 74 | pulling device |
| 75 | joint members |

1. Furniture unit (1) having at least one box-shaped frame body (2) defined by two side panels (4) wherein at least one side panel (4) comprises at least two functional sections (5, 6) where at least one fitting section (7) is disposed for attaching to the fitting section (7) at least one furniture element (8), wherein one of the functional sections (5, 6) serves as a front and one as the rear functional section and the fitting section (7) extends between the front functional section (5) and the rear functional section (6) and is supported on the two functional sections (5, 6), wherein at least one first peg (9) extends from one of the two functional sections (5, 6) into a first groove (11) of the fitting section, and that a vertically offset, second peg (10) extends from one of the two functional sections (5, 6) into a second groove (12) of the fitting section (7) for supporting the fitting section (7).

2. The furniture unit (1) according to claim 1 wherein the fitting section (7) is configured as a narrow, upright section.

3. The furniture unit (1) according to claim 1 wherein the first groove (11) is provided on an inner longitudinal face (13) and the second groove (2), on the outer longitudinal face (14) of the fitting section (7).

4. The furniture unit (1) according to claim 1 wherein at least one further groove (23) is provided at the fitting section (7) and is preferably provided beneath the first and second grooves (11, 12) and in particular on the outer longitudinal face (14).

5. The furniture unit (1) according to claim 1 wherein at least one groove (11, 12) extends over the entire length of the fitting section (7).

6. The furniture unit (1) according to claim 1 wherein at least one peg (9, 10) extends from the front functional section (5) up to the rear functional section (6).

7. The furniture unit (1) according to claim 1 wherein the fitting section (7) has at least one end and the one end is provided with at least two pegs (9, 10).

8. The furniture unit (1) according to claim 1 wherein the fitting section (7) has an outer top edge (15) and at least the outer top edge (15) is at least approximately rounded in shape.

9. The furniture unit (1) according to claim 1 wherein the fitting section (7) has an inner longitudinal face (13) that is provided with multiple holes (17) which are disposed in particular equidistantly and at least in part at the same height.

10. The furniture unit (1) according to claim 9 wherein at least one functional section (5, 6) has at least one hole (18) at the height of the holes (17) of the fitting section (7).

11. The furniture unit (1) according to claim 1 further comprising at least one side panel (4), the side panel (4) comprising a partition frame (20) that is formed by at least one front functional section (5), at least one rear functional section (6), at least one top beam (21) and at least one bottom beam (22) which are in particular articulated to one another.

12. The furniture unit (1) according to claim 1 further comprising a second and adjacent frame body (2) and an exchangeable partition panel (19) between the frame bodies which is in particular received at a partition frame (20).

13. Furniture unit (1) comprising at least two adjacent, box-shaped accommodating spaces (3) which are separated from one another by a partition frame (20), the partition frame (20) comprising two front functional sections (5) and two rear functional sections (6) and a top and a bottom beam (21, 22) and is supported on a top cross bar (31) and a bottom cross bar (32), wherein the front functional sections (5) and the rear functional sections (6) and the top and bottom beams (21, 22) are articulated to one another, wherein the bottom beam (22) comprises an engaging lug (29) so that the support frame (20) engages and is retained at the bottom cross bar (22) in a slot (33) at the bottom cross bar by means of the engaging lug (29), and that the top beam (21) engages and is retained in a slot (33) of the top cross bar (31) by means of at least one engaging lug (29).

14. The furniture unit (1) according to claim 13 wherein the top beam (21) comprises two beam parts (26, 27) disposed in parallel wherein one of the two beam parts (26) is connected to a supporting lug (28) and the other, an engaging lug (29), so that the partition frame (20) engages the top cross bar (31) by means of the engaging lug (29) of the top beam (21).

15. The furniture unit (1) according to claim 14 wherein the bottom beam (22) comprises two beam parts (26, 27) disposed in parallel wherein one of the two beam parts (26, 27) is connected to a supporting lug (28) and the other, an engaging lug (29), so that the partition frame (20) engages the bottom cross bar (32) of the bottom beam (22) by means of the engaging lug (29) of the bottom beam (22).

16. The furniture unit (1) according to claim 15 wherein the engaging lugs (29) of the top and bottom beams (21, 22) are angled and facing one another.

17. The furniture unit (1) according to claim 15 further comprising joint members (75) and wherein the front and rear functional sections (5, 6) and the top and bottom beams (21, 22) are provided with holes (24) into which the joint members (75) are pushed to form a four-bar mechanism (25).

18. The furniture unit (1) according to claim 13 wherein a partition panel (19) is received at the partition frame (20).

19. The furniture unit (1) according to claim 18 wherein a width of the beam (21, 22) is not larger than half the width of the partition panel (19) and in particular corresponds to approximately half the width of the partition panel (19).

20. The furniture unit (1) according to claim 13 wherein at least one adjusting unit (50) is provided at the partition frame (20).

21. The furniture unit (1) according to claim 13 wherein the box-shaped accommodating space (3) is defined by a stackable frame body (2) whose sides are formed by the partition frames (20) wherein at least one functional section (5, 6) defines top and/or bottom guide holes (34) for joining two stacked frame bodies (2) to one another by inserting retaining pins (35) into the guide holes (34).

22. The furniture unit (1) according to claim 21 wherein at least one frame body (2) is retained at least at one of the cross bars (31, 32).

23. The furniture unit (1) according to claim 1 wherein a box, a drawer, a door, a trap door or an appliance or the like is attached to the fitting section (7).
